(19) United States
(12) Patent Application Publication
(10) Pub. No.: US 2007/0087263 A1
(43) Pub. Date: Apr. 19, 2007

(54) BATTERY COVER LATCHING ASSEMBLY FOR PORTABLE ELECTRONIC DEVICE

(75) Inventors: Peng-Jin Ge, Shenzhen (CN); Rui-Hao Chen, Shenzhen (CN); An-Ming Feng, Shenzhen (CN); Hsiao-Hua Tu, Shindian (CN); Chia-Hua Chen, Shindian (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: FIH CO.,LTD., Taipei Hsien (TW)

(21) Appl. No.: 11/309,367

(22) Filed: Aug. 1, 2006

(30) Foreign Application Priority Data
Oct. 14, 2005 (CN) 200510100357.8

(51) Int. Cl. H01M 2/10

(52) U.S. Cl. 429/97; 429/10; 429/100

(57) ABSTRACT

An exemplary battery cover latching assembly (80) is used in a portable electronic device (100). The portable electronic device has a battery cover and a housing releasably mounted with the battery cover latching assembly. The housing has a cavity. The battery cover latching assembly includes a latching member, a first magnetic member, and a second magnetic member. The latching member is received in the cavity of the housing and is slidable in a first direction. The first magnetic member is mounted to the latching member. The second magnetic member is mounted to the housing. The second magnetic member cooperates with the first magnetic member to create force acting in the first direction to enable the latching member to mount the battery cover to the housing.

### DESCRIPTION

1. FIELD OF THE INVENTION

The present invention generally relates to battery cover latching assemblies and, more particularly, to a battery cover latching assembly for use in a portable electronic device.

2. DESCRIPTION OF RELATED ART

Batteries are widely used in portable electronic devices, such as personal digital assistants (PDAs), mobile phones, and the like. Conventional batteries are attachably received in housings of the electronic device, and battery covers are designed to connect with the housings to package the batteries. The batteries have to be replaced by opening the battery covers when the batteries are, e.g., damaged, dead, and/or otherwise in need of recharging or replacement.

A clasping structure or latching structure is used to engage a conventional battery cover with a housing of a portable electronic device. For example, the Alcatel OT310 mobile phone has a latching assembly for a battery cover. The latching assembly includes two hooks at one end of the battery cover and a locking pin protruding from the other end of the battery cover. Two grooves are defined in one end portion of a backside of a housing of the mobile phone, and a locking hole is defined in the other end portion of the backside of the housing. In assembly, the hooks are firstly inserted into the grooves in the backside of the housing. Then, the battery cover is pressed downwards onto the housing until the locking pin on the battery cover is inserted into the locking hole in the backside of the housing. The battery cover is thus assembled to the housing of the mobile phone. The latching assembly is simple in structure, and the engagement between the battery cover and the housing of the mobile phone is firm, too. However, during disassembly, great effort is needed to remove the battery cover, thereby requiring a relatively substantial force to be exerted thereon. Therefore, the battery cover can be susceptible to damage. As a result, it can be difficult for a user to replace a battery in the conventional housing of the mobile phone.

Therefore, a new battery cover latching assembly is desired in order to overcome the above-described shortcomings.

### SUMMARY OF THE INVENTION

In one embodiment thereof, a portable electronic device has a battery cover, a battery cover latching assembly, and a housing. The housing has a cavity. The battery cover latching assembly includes a latching member, a first magnetic member, and a second magnetic member. The latching member is received in the cavity of the housing and is slidable in a first direction. The first magnetic member is mounted to the latching member. The second magnetic member is mounted to the housing. The second magnetic member cooperates with the first magnetic member to create force acting in the first direction to enable the latching member to mount the battery cover to the housing.

Other advantages and novel features of the embodiments will become more apparent from the following detailed description thereof, when taken in conjunction with the accompanying drawings.

### BRIEF DESCRIPTION OF THE DRAWINGS

Many aspects of the battery cover latching assembly can be better understood with reference to the following drawings. The components in the drawings are not necessarily drawn to scale, the emphasis instead being placed upon clearly illustrating the principles of the present battery cover latching assembly and its potential applications. Moreover, in the drawings, like reference numerals designate corresponding parts throughout the several views.

FIG. 1 is an exploded, isometric view of a portable electronic device with a battery cover and a housing connected via a battery cover latching assembly, in accordance with a preferred embodiment;

FIG. 2 is similar to FIG. 1, but viewed from another aspect;

FIG. 3 is an enlarged, assembled view of the portable electronic device shown in FIG. 2;

FIG. 4 is similar to FIG. 4, but viewed from another aspect;

FIG. 5 is a cut-away view of the portable electronic device along line V-V shown in FIG. 4.

### DETAILED DESCRIPTION OF THE EMBODIMENTS

The present battery cover latching assembly is suitable for portable electronic devices, such as mobile phones, PDAs, and so on.

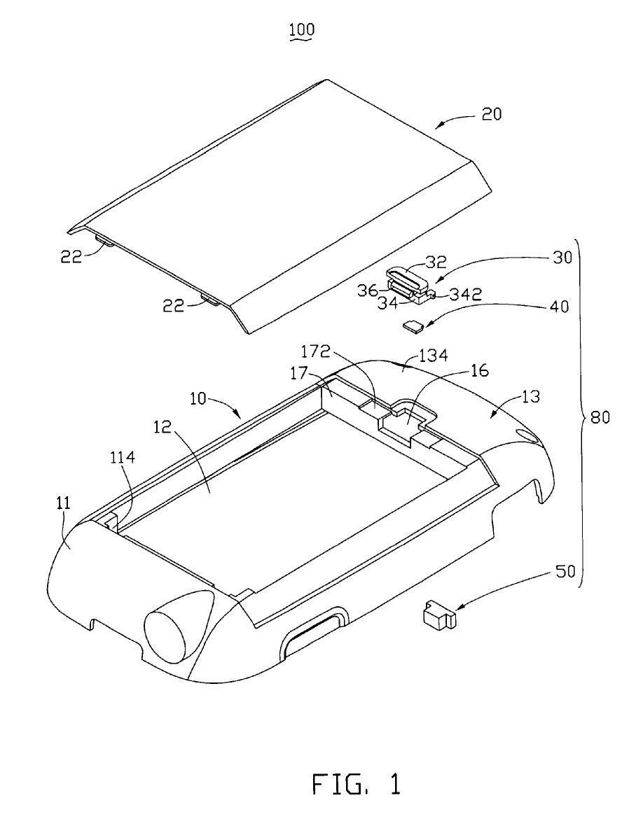

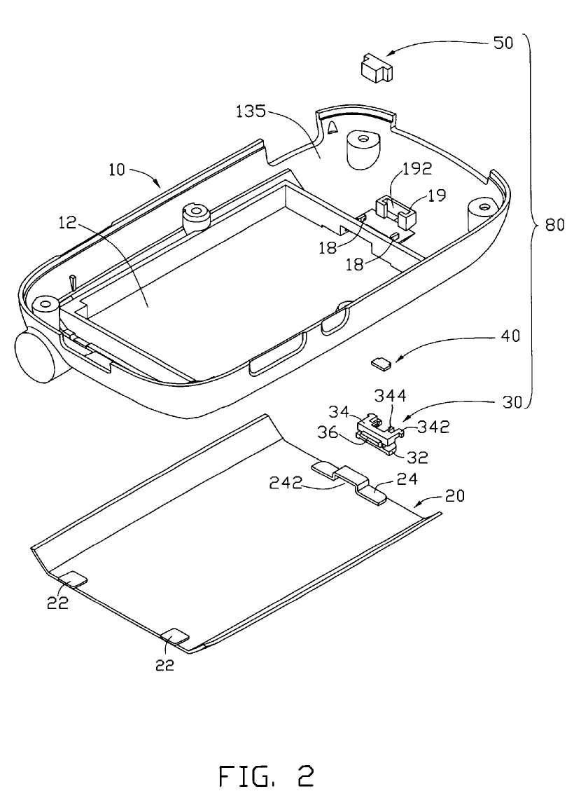

Referring now to the drawings in detail, FIG. 1 shows a battery cover latching assembly 80 for use in a mobile phone 100. The mobile phone 100 is taken here as an exemplary application, for the purposes of describing details of the battery cover latching assembly 80 of a preferred embodiment of the present assembly. The mobile phone 100 includes a housing 10 and a battery cover 20, connected via the battery cover latching assembly 80. Also referring to FIG. 2, the battery cover latching assembly 80 includes a latching member 30, a first magnetic member 40, and a second magnetic member 50. The housing 10 defines a cavity 16 therein. The battery cover latching assembly 80 is mounted in the cavity 16 of the housing 10 and releasably locks the battery cover 20, thereby interconnecting the housing 10 and the battery cover 20.

Further referring to FIG. 2, the housing 10 is a substantially rectangular board and has a rounded sidewall formed on a periphery of the board. The housing 10 defines a battery cavity 12 in a central portion thereof thereby forming a bottom wall 11, a top wall 13, and a partition wall 17. The battery cavity 12 is for receiving a battery therein. The bottom wall 11 is opposite to the top wall 13. The bottom wall 11 defines two positioning holes 114 in two ends. The positioning holes 114 communicate with the battery cavity 12. The partition wall 17 defines a cutout 172 in a central portion. The cutout 172 has a T-shaped cross-section. The top wall 13 defines the cavity 16 therethrough. The cavity 16 communicates with the cutout 172. The top wall 13 has an outer surface 134 and an inner surface 135. The outer surface 134 is opposite to the inner surface 135. Two positioning hooks 18 extend from the inner surface 135 and adjacent to the cavity 16. A block 19 extends from the inner surface 135 and adjacent to the positioning hooks 18. The block 19 defines a notch 192 therein. The notch 192 has a T-shaped cross section.

The battery cover 20 is substantially a rectangular board. Two positioning flakes 22 are formed at one end of the battery cover 20. The two positioning flakes 22 are engaged in the two respective positioning holes 114 of the housing 10. A rectangular locking board 24 is formed at an opposite end of the battery cover 20. A central portion of the locking board 24 is bent to define a locking hole or slot 242 therein.

The latching member 30 includes an operation portion 32, a positioning portion 34, and a block 36. The operation portion 32 is a substantially elliptical board in shape. The operation portion 32 defines a hole in one end thereof for ease of pushing. The positioning portion 34 is connected to the operation portion 32. Two outer hooks 342 extend from one end of the positioning portion 34. The two outer hooks 342 face away from each other. Two inner hooks 344 extend from the end of the positioning portion 34 and in a same direction as the outer hooks 342. The two inner hooks 344 face towards each other. The block 36 is formed at a joint between the operation portion 32 and the positioning portion 34. The block 36 is substantially wedge-like in shape.

The first magnetic member 40 and the second magnetic member 50 can be permanent magnets. The first magnetic member 40 has a T-shaped cross-section and is configured for being received between the two inner hooks 344 of the latching member 30. A first end of the first magnetic member 40 is exposed from the inner hooks 344. The second magnetic member 50 has a T-shaped cross-section and is configured for being received in the notch 192 of the housing 10. A second end of the second magnetic member 50 is exposed out of the notch 192. The first end of the first magnetic member 40 and the second end of the second magnetic member 50 have identical polarity.

In assembly, the first magnetic member 40 is mounted between the two inner hooks 344 of the latching member 30. The first end of the first magnetic member 40 is exposed from between the inner hooks 344. The second magnetic member 50 is mounted in the notch 192 of the housing 10. The second end of the second magnetic member 50 is exposed out of the notch 192. The positioning portion 34 of the latching member 30 travels through the cavity 16. Each of the outer hooks 342 engages with a corresponding positioning hook 18, and the latching member 30 is thereby mounted on the housing 10. The operation portion 32 is exposed out from the outer surface 134. The block 36 is pushed away from the second magnetic member 50 due to force acting between the first magnetic member 40 and the second magnetic member 50. The first end of the first magnetic member 40 faces towards the second end of the second magnetic member 50. Thus, the battery cover latching assembly 80 is assembled in the housing 10 and is slidable in a horizontal direction.

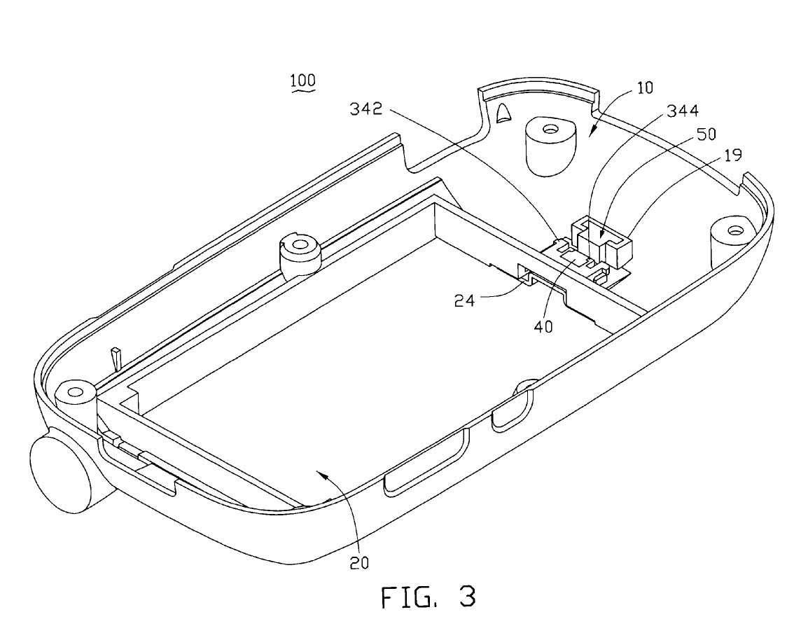

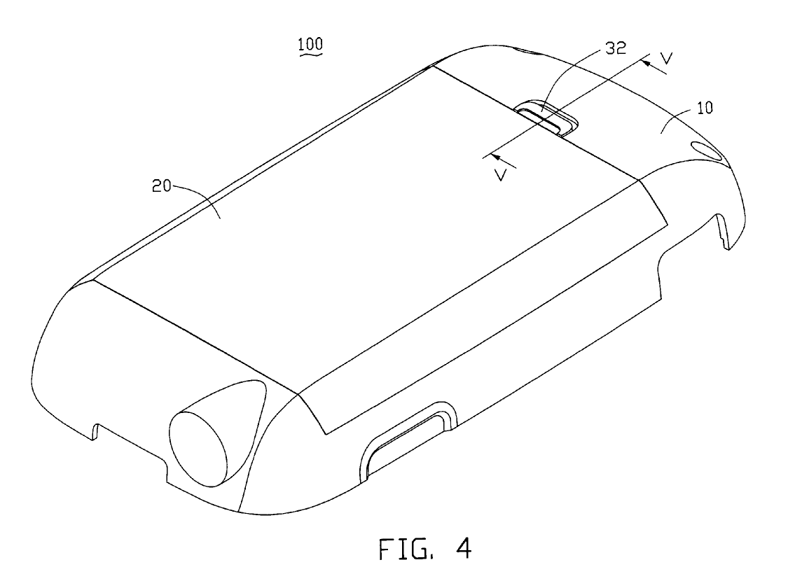

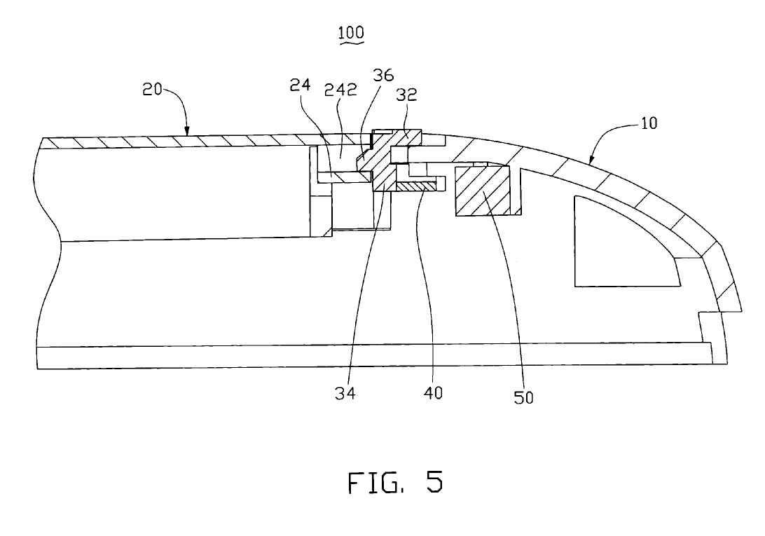

When the battery cover 20 is assembled to the housing 10, the positioning flakes 22 of the battery cover 20 are received in the positioning holes 11 4 of the housing 10. The opposite end of the battery cover 20 is pressed down onto the housing 10. When the locking board 24 touches the block 36, the battery cover 20 is held down and the block 36 and then the latching member 30 are moved away from the battery cover 20 by the locking board 24. When the block 36 faces towards the locking slot 242, the block 36 is moved into the locking slot 242 due to the force acting between the first magnetic member 40 and the second magnetic member 50. Thus, the battery cover 20 is assembled with the housing 10, as represented in FIGS. 3-5.

When the battery cover 20 is to be detached from the housing 10, the operation portion 32 of the latching member 30 is manually moved away from the battery cover 20. The block 36 of the latching member 30 correspondingly moves out of engagement with the locking slot 242 of the battery cover 20. The battery cover 20 is pulled away from the housing 10 manually. By releasing the operation portion 32, the block 36 is moved away from the second magnetic member 50 due to the force from the first magnetic member 40 and the second magnetic member 50.

It is to be understood that the battery cover 20 may have a block formed at one end thereof. The latching member 30 may defined a locking slot therein for receiving the block of the battery cover 20.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A battery cover latching assembly for a portable electronic device, the portable electronic device having a battery cover and a housing releasably mounted with the battery cover latching assembly, the housing having a cavity, the battery cover latching assembly comprising:
a latching member received in the cavity of the housing and being slidable in a first direction;
a first magnetic member mounted to the latching member; and
a second magnetic member mounted to the housing, and the second magnetic member cooperating with the first magnetic member to create force acting in the first direction to enable the latching member to mount the battery cover to the housing.

2. The battery cover latching assembly as claimed in claim 1, wherein the adjacent two ends of the first magnetic member and the second magnetic member have identical polarity.

3. The battery cover latching assembly as claimed in claim 1, wherein the latching member has a first locking member, and the battery cover has a second locking member configured for engaging with the first locking member, the latching member thereby mounting battery cover to the housing.

4. The battery cover latching assembly as claimed in claim 3, wherein one of the first locking member and the second locking member is a block, and the other of the first locking member and the second locking member is a locking slot for slidably receiving the block.

5. The battery cover latching assembly as claimed in claim 4, wherein the block is substantially wedge-like in shape.

6. The battery cover latching assembly as claimed in claim 1, wherein the housing has a top wall, and the top wall defines the cavity.

7. The battery cover latching assembly as claimed in claim 6, wherein the latching member further includes a positioning portion and two outer hooks extending from two ends of the positioning portion, and where two positioning hooks extend from the top wall and adjacent to the cavity for engaging with the outer hooks of the latching member thereby mounting the latching member in the cavity of the housing.

8. The battery cover latching assembly as claimed in claim 7, wherein a block extends from the top wall and the block defines a notch therein for receiving the second magnetic member.

9. The battery cover latching assembly as claimed in claim 8, wherein the positioning portion of the latching member has two inner hooks extended therefrom and the first magnetic member is mounted between the inner hooks.

10. A portable electronic device comprising:
a battery cover having a first locking member;
a housing having a cavity; and
a battery cover latching assembly releasably mounting the battery cover to the housing, the battery cover latching assembly comprising:
a latching member having a second locking member, the latching member being received in the cavity of the housing and being slidable in a first direction;
a first magnetic member mounted to the latching member; and
a second magnetic member mounted to the housing, the second magnetic member cooperating with the first magnetic member to enable the second locking member of the latching member to engage with the first locking member of the battery cover thereby mounting the battery cover to the housing.

11. The portable electronic device as claimed in claim 10, wherein the second magnetic member cooperates with the first magnetic member to give a force in the first direction to the latching member.

12. The portable electronic device as claimed in claim 11, wherein the adjacent two ends of the first magnetic member and the second magnetic member have identical polarity.

13. The portable electronic device as claimed in claim 10, wherein one of the first locking member and the second locking member is a block, and the other of the first locking member and the second locking member is a locking slot for slidably receiving the block.

14. The portable electronic device as claimed in claim 13, wherein the block is substantially wedge-like in shape.

15. The portable electronic device as claimed in claim 10, wherein the housing has a top wall, and the top wall defines the cavity, the latching member further includes a positioning portion and two outer hooks extending from two ends of the positioning portion, and two positioning hooks extend from the top wall and adjacent to the cavity for engaging with the outer hooks of the latching member thereby mounting the latching member in the cavity of the housing.

16. The portable electronic device as claimed in claim 15, wherein the positioning portion of the latching member has two inner hooks extending therefrom and the first magnetic member is mounted between the inner hooks.
